(19) United States
(12) Patent Application Publication
(10) Pub. No.: US 2007/0045352 A1
(43) Pub. Date: Mar. 1, 2007

(54) Apparatus and method for dispensing fluids

(75) Inventors: Christer Ohlin, Varmdo (SE); Lars Olsson, Tyreso (SE); Johan Sundevall, Arsta (SE)

Correspondence Address: AKZO NOBEL INC., INTELLECTUAL PROPERTY DEPARTMENT, 120 WHITE PLAINS ROAD 3RD FLOOR, TARRTOWN, NY, 10591, US

(73) Assignee: AKZO NOBEL COATINGS INTERNATIONAL B.V., Arnhem (NL)

(21) Appl. No.: 11/505,703

(22) Filed: Aug. 17, 2006

Related U.S. Application Data
(60) Provisional application No. 60/711,419, filed on Aug. 26, 2005.

(51) Int. Cl. G01F 11/00

(52) U.S. Cl. 222/386; 222/132; 222/324

(57) ABSTRACT

The present invention relates to a dispensing apparatus comprising first and second valve units (9; 10) each having an output for delivering a liquid under pressure; a liquid application means coupled to said valve units, the liquid application means having a contact surface (2) and at least two separated, co-extensive outputs (5; 6) in said contact surface respectively communicating independently with said outputs of said first and second valve units; said co-extensive outputs mouthing in succession into a channel (7) which is recessed from said contact surface; said channel mouthing in a trailing end of said contact surface and having a flow cross-section that increases stepwise for every additional liquid that is successively discharged through said co-extensive outputs. The invention also relates to a method for dispensing liquids onto a substrate.

This application claims priority based on U.S. Provisional Patent Application Ser. No. 60/711,419, filed Aug. 26, 2005.

The present invention relates to dispensing apparatuses by which a liquid is applied in parallel strings to a surface of a substrate, and transferred by means of a contact surface sweeping the surface of said substrate while discharging the liquid through multiple outputs. The invention further relates to a method of forming a string of combined liquids on the surface of a substrate moving in a feed direction under contact with a dispensing apparatus.

### BACKGROUND AND PRIOR ART

The dispensers referred to are frequently used in applications wherein adhesive is applied to a surface of a piece of material that is successively combined with other such pieces in a laminated structure, such as a wood laminate. In the wood lamination industry, pieces of wood are typically conveyed to pass in succession a dispensing apparatus by which adhesive is distributed to the wood pieces in the form of parallel strings. Basically, adhesive is discharged under pressure through multiple outputs opening in a contact surface, facing the substrate and sweeping the surface thereof under contact.

In this context, prior art may be represented by an edge and face lamination head comprising an upright contact surface arranged for transferring adhesive to a vertical surface of a work piece that is moved in a feed direction to pass the contact surface rectilinearly under contact. Adhesive is discharged via multiple outputs arranged above each other in a single row. Each said output mouths into an associated groove which is recessed from the contact surface and extended in the feed direction to terminate in a downstream end of the contact surface. Adhesive is distributed to the outputs from a cavity having an inlet, to which the adhesive is supplied over a control valve arranged ahead of the inlet, i.e. upstream thereof, as viewed in a feed direction of adhesive. This type of dispensing apparatus is commercially available from the U.S. based APQUIP® Company, LLC.

A problem associated with the feed of curable liquids, such as components of a curing adhesive system, through dispensing apparatuses in general is the risk of curing in the apparatus, eventually clogging the discharge nozzles or outputs. In this aspect, curing on the contact surface and grooves is a further risk connected with the type and structure of dispensers referred to in the present application.

Another problem encountered in the course of feeding adhesive for distribution from a multiplicity of outputs is the risk of uneven discharge of adhesive over the row of outputs, resulting in uneven and unsatisfactory bonding. This problem may be further expressed when the pressure drop over the outputs is low, resulting in a heavier flow through an output close to the inlet than through the next output in the row.

Yet another problem referable to the start sequence controlling the flow of adhesive from a multiplicity of outputs supplied via a singular control valve is the risk of excessive discharge of adhesive in the start sequence due to an initial pressure at the outputs. This effect may be further accentuated when the apparatus operates at higher feed pressure.

In operation for gluing wood laminates, e.g., the start and stop sequence is synchronized with the feed of wood pieces at speeds in the order of 100 m/min or more. In order to ensure that discharge of adhesive is accurately synchronized with the fore and aft ends of each wood piece, the control valve must be operated at high shifting speeds between opening and closing. Thus, shifting from a full flow to a full stop, or the reversed, is associated with considerable pressure surges that affects and impairs the discharge of adhesive.

Still another problem associated with the feed of adhesive through dispensing apparatuses in general is the risk of gas or air entrapment and stagnant volumes of adhesive, referable basically to the intermittent feed and internal design of a dispensing apparatus.

### SUMMARY OF THE INVENTION

One object of the present invention is to provide a dispensing apparatus avoiding one or several of the above problems. Another object is to provide an improved liquid dispensing procedure whereby one or several of the above problems can be avoided. These objects are met through the dispensing apparatus and method as specified in the appended claims.

Briefly, in a first aspect of the invention, undesired curing and clogging in the dispensing apparatus is avoided by separating curable liquid components to be combined in a string on the receiving surface to be bonded.

According to this first aspect, a dispensing apparatus comprises first and second valve units each having an output for delivering a liquid under pressure; a liquid application means coupled to said valve units, the liquid application means having a contact surface and at least two separated, co-extensive outputs in said contact surface respectively communicating independently with said outputs of said first and second valve units; said co-extensive outputs mouthing in succession into a channel which is recessed from said contact surface; said channel mouthing in a trailing end of said contact surface and having a flow cross-section that increases stepwise for every additional liquid that is successively discharged through said co-extensive outputs.

In a second aspect of the invention, mixing of curable liquid components on the contact surface is avoided by formation of a composite liquid string wherein successively discharged liquids are controlled for encapsulation of the previously discharged liquid.

According to this second aspect, each stepwise increased flow cross-section of said channel has a depth and a width dimension, both greater than a depth and width dimension of the previous flow cross-section of said channel.

According to a third aspect of the invention, a dispensing apparatus comprising first and second co-extensive rows of outputs is provided, the output from said first and second valve units including individual opening/closing members for each output included in one of said co-extensive rows of outputs. This way, uneven discharge of liquid over the row of outputs is avoided.

Advantageously, said first and second valve units each include a valve plunger that is axially adjustable between opening and closing positions, said valve plunger on its outside carrying opening grooves separated by closing lands running about the plunger periphery, from a first to a second edge of an elongate cavity opening in the plunger side.

In a fourth aspect of the invention, stagnant liquid volumes during intermittent operation can be avoided in a dispensing apparatus wherein first and second pumps are respectively coupled to said first and second valve units for supplying liquid independently to each valve unit, and wherein the output from said first and second valve units includes an opening/closing means in flow communication with said pumps and operated in the reverse to said individual opening/closing members.

In a fifth aspect of the invention, excessive pressure surges can be avoided through a continuous feed of liquid also during intermittent operation.

According to this fifth aspect, said first and second valve units each include a valve plunger that is axially adjustable between opening and closing positions, an elongate cavity formed in said plunger, said cavity having an inlet end and a remote end both communicating with one of said first and second pumps, said inlet end continuously opened for supply of liquid into the cavity and said remote end opening for recirculation of liquid to the pump when the plunger is adjusted for closing the outputs in one of said co-extensive rows of outputs.

Advantageously, the dispensing apparatus of the present invention has a modular design, comprising a dispensing module supporting a contact plate, both mountable on a valve module, at least two valve plungers receivable in seats formed in the valve module, and a drive unit mountable on the valve module and connectable to the valve plungers.

An interconnecting element may be arranged, by which the first and second valve plungers are concurrently operable by a singular drive unit.

Alternatively, the first and second valve plungers are individually operable by separate drive units.

Advantageously, the contact surface is formed with a trailing end and a leading end, both of which adjoin an extension that is curved or angled out of a plane of contact.

Through the measures suggested above, an improved method for dispensing liquids onto a substrate moving in a feed direction under contact with a dispensing apparatus may be achieved. Advantageously, the steps provided herein are applicable to a process for dispensing adhesive to the substrate, wherein preferably a first and second liquid are components of a curing adhesive system, such as hardener and resin, respectively.

The new method comprises the steps of:
dispensing from said apparatus a first and a second liquid separately via outputs, co-extensive in said feed direction;
forming by said apparatus a string of said first liquid on the substrate, and successively,
adding said second liquid to said first liquid, forming by said apparatus a string of combined liquids on the substrate, wherein the second liquid is formed to a string that encapsulates the first liquid previously dispensed to the substrate.

According to yet a further aspect of the method, the liquids are delivered individually to multiple outputs arranged in co-extensive rows of outputs, also comprising the step of individually opening and closing, respectively, each output in one of said coextensive row of outputs.

The method may further comprise the step of continuously feeding the first and second liquids through said dispensing apparatus.

In still another aspect, the method comprises the step of controlling the continuous feed of the first and second liquids for recirculation of liquid in reverse to dispensing.

The present invention also includes the use of the dispensing apparatus herein described for dispensing liquids, preferably adhesive components, onto a substrate.

### BRIEF DESCRIPTION OF THE DRAWINGS

The invention will be further explained below, by reference to the drawings showing embodiments of the invention. In the drawings,

FIG. 1 is a perspective view showing a first embodiment of the dispensing apparatus;

FIG. 2 shows the first embodiment in an exploded view;

FIG. 3 is a front view showing a second embodiment of the dispensing apparatus;

FIG. 4 shows the second embodiment in an exploded view;

FIG. 5a is a sectional view showing a plane V through the apparatus of FIG. 3 in dispensing mode;

FIG. 5b is a similar view showing the apparatus of FIG. 3 in re-circulation mode;

FIG. 6 is a sectional view showing a plane VI through the apparatus of FIG. 3;

FIG. 7a is a broken away sectional view, showing on a larger scale a string-forming channel, and,

FIG. 7b is a broken away top view showing the same.

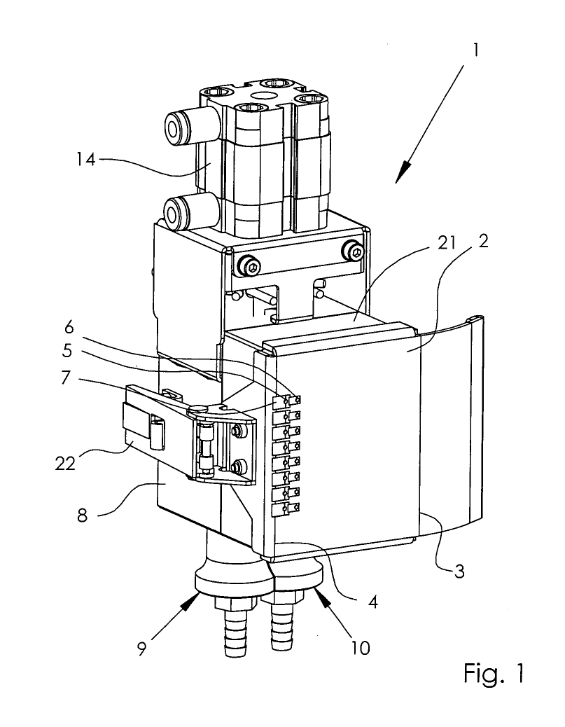

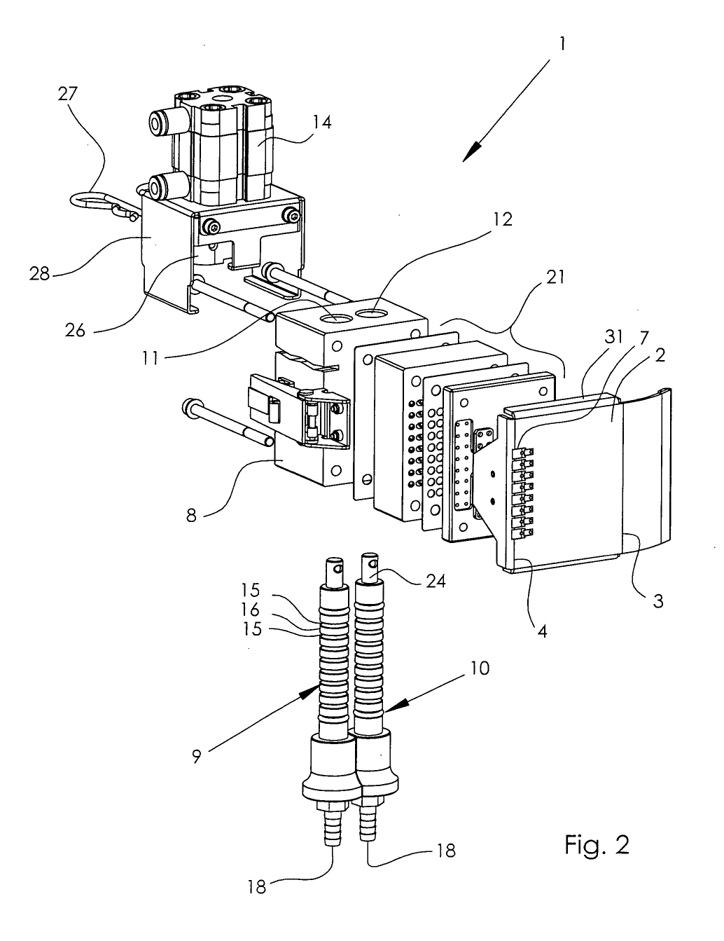

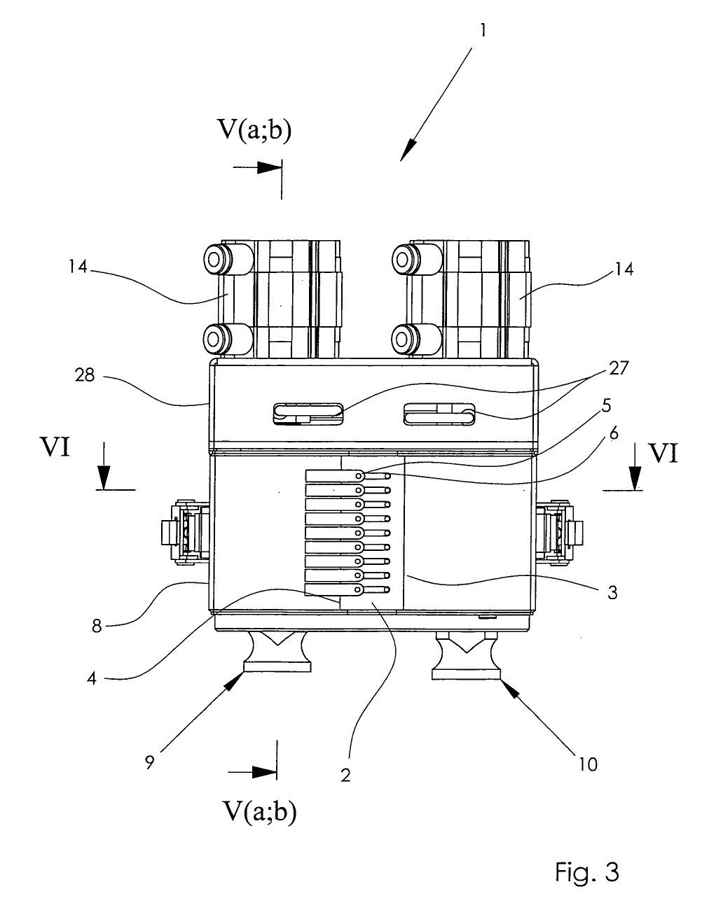

### DETAILED DESCRIPTION OF THE INVENTION

In the following, the two embodiments will be explained in parallel with reference to the drawings 1-7b, wherein corresponding elements are assigned identical reference numbers.

A dispensing apparatus 1 according to the present invention typically has a contact surface 2 having a leading end 3 and a trailing end 4, and by which liquid is transferred to a substrate that is moved rectilinearly from the leading end towards the trailing end under contact with the contact surface. As used in this connection, the expressions “leading end” and “trailing end” refer to the fore and aft margins of the contact surface between which mutual contact exists between the moving substrate and the contact surface during dispensing of liquids. Liquid is supplied under pressure and discharged through multiple outputs opening in the contact surface. The outputs are arranged in rows extended transversely to the feed direction, forming on the substrate parallel strings extending in the feed direction.

In the embodiments illustrated the outputs are arranged in two successive, co-extending rows with respect to the feed direction. Liquid being discharged from a down-stream output 5 is successively combined on the substrate with liquid that is previously discharged from an up-stream, co-extensive output 6. The number of outputs in each row, as well as the number of rows co-extensive in the feed direction, is variable according to the application in question.

Liquid is supplied separately to the co-extensive rows of outputs. Each row of outputs communicates with the output of a separate valve unit, controlling the distribution of liquid that is pumped from separate supplies of liquid. Typically, the liquids are components of an adhesive system, such as hardener component and resin component, which are combined to a string of a curable adhesive system on the substrate. The dispensing apparatus is however not structurally limited to the type and character of liquid used, neither is the suggested method.

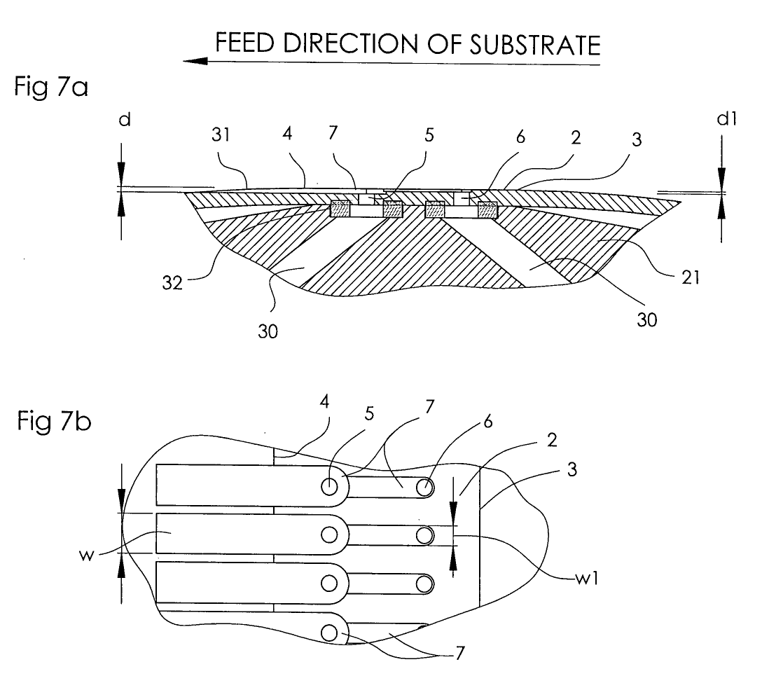

The outputs 5 and 6, co-extending in the feed direction, open into a common channel 7. The channel or channels 7 are recessed from the contact surface, extended in the feed direction to mouth in the trailing end of the contact surface, with respect to the relative movement between the contact surface and a substrate. As is diagrammatically illustrated in FIGS. 7a and 7b, the channel 7 has a flow cross-section the area of which increases stepwise for every additional liquid that is successively discharged through said co-extensive outputs. The outputs are arranged to open in the very up-stream end of each said successive section of the channel. Each successive section of the channel thus has a depth or/and a width which is greater than the depth or/and width of a previous section of the channel 7. Advantageously, each successive section of the channel has a depth and a width dimension d and w, respectively, which are both greater than a depth and width dimension d₁, w₁ of the previous section of the channel. In effect of the greater depth dimension of each successive section of the channel, the successive one of the co-extensive outputs opens into the channel below the recessed bottom of the previous channel section. This way a combined liquid string may be formed on the substrate, wherein successively discharged liquids are controllable for encapsulation of the liquid discharged from the previous one of the co-extensive outputs. As a result, curable liquids are prevented from mixing on the contact surface, thus also preventing any clogging of the outputs caused by curing liquid components.

The contact surface with co-extensive rows of outputs is supported on a valve body 8. First and second valve units, as well as any additional valve unit if appropriate, comprises first and second valve plungers 9, 10 received in corresponding valve seats 11, 12 formed in the valve body.

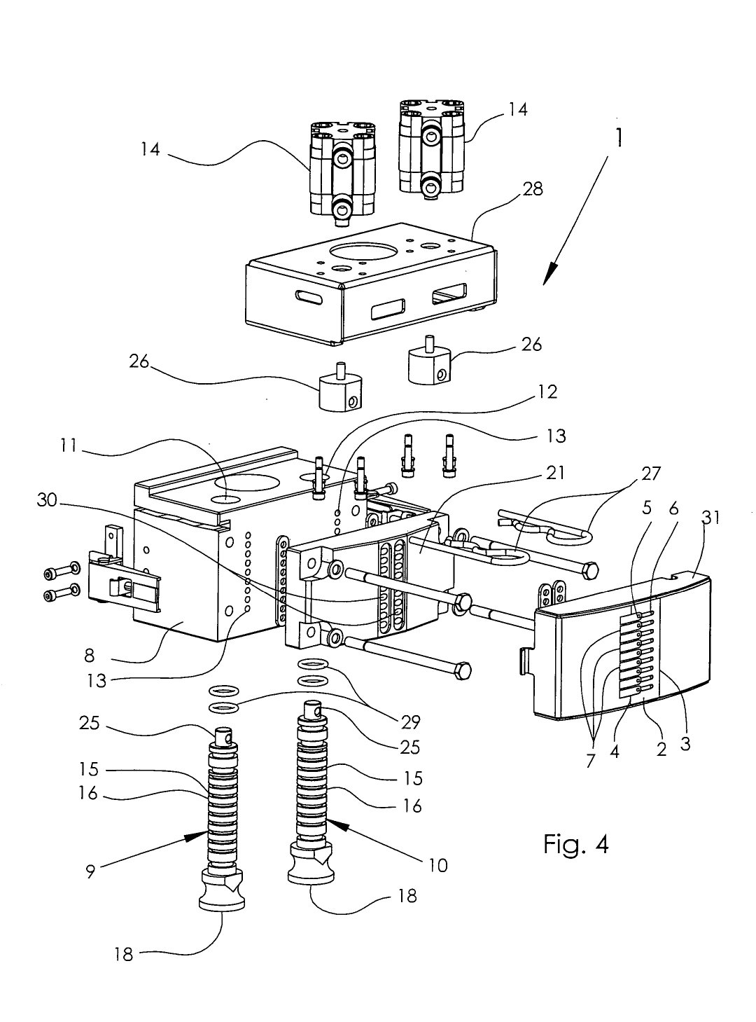

As is better understood from FIGS. 4-6, the output from each valve unit is separately in flow communication with a respective one of said co-extensive rows of outputs. Each singular output in a co-extensive row of outputs is individually supplied from the. corresponding valve unit, via individual passages 13 formed through the valve body and mouthing in the valve seat and on a side of the valve module.

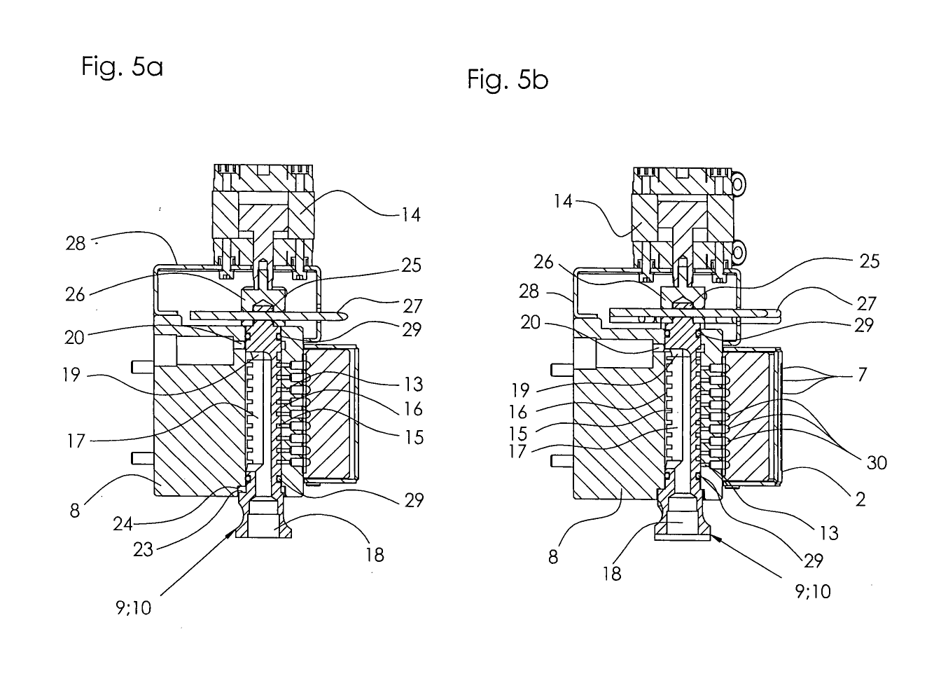

The outputs from each said first and at least one second valve units include individual opening/closing members for each output included in one of said co-extensive rows of outputs. The valve units each include a valve plunger sealingly received in the associated seat and axially adjustable therein between opening and closing positions, operated for opening/closing movements by a linear drive unit 14 supported on the valve body. On its outer surface, the valve plunger carries opening grooves 15 separated by closing lands 16 running about the plunger periphery, from a first to a second edge of an elongate cavity 17 opening in the plunger side, as best understood from FIGS. 5a and 5b. The grooves are separated by a distance corresponding to the distance separating the mouths of said passages 13, as viewed in an axial direction of the valve plunger and seat. Liquid is supplied to the cavity via an inlet end 18, the liquid under pressure filling the cavity and the continuous grooves 15 which are open towards the wall of the valve seat. In the open position, FIG. 5a, the valve plunger is adjusted to level the grooves 15 with the mouths of the passages 13, simultaneously feeding liquid individually to each output in the associated row of outputs. In the closing position, FIG. 5b, the valve plunger is adjusted to level the lands 16 with the mouths of said passages 13, this way instantly blocking liquid flow to each output in the associated row of outputs.

The first and second valve units are coupled to first and second pumps, respectively (not shown in the drawings), each pump supplying liquid independently to the associated valve unit. Advantageously, the liquid output from the valve units each includes an opening/closing means operated in the reverse to said individual opening/closing means, and in flow communication with the pump. To this purpose, the plunger cavity has an inlet end 18 and a remote end 19 both communicating with the pump. The inlet end is constantly open for continuous supply of liquid into the cavity, whilst said remote end opens for re-circulation of liquid from the cavity to the pump when the plunger is shifted for closing the outputs in one of said co-extensive rows of outputs. A re-circulation passage 20, connectable to the pump, is arranged in the valve module to open in the valve seat wall opposite to the plunger cavity, as well as on a side of the valve module. The mouth of the passage 20 in the valve seat is sealed by the valve plunger when the plunger is shifted for dispensing liquid by opening the outputs in one of said co-extensive rows of outputs, said mouth opening for re-circulation of liquid from the remote end 19 of the plunger cavity when the valve plunger is operated in the reverse. The re-circulation via the passage 20 allows for continuous operation of the pump and circulation of liquid at a continuous pressure level in dispensing and re-circulation modes. In re-circulation mode, liquid is thus continuously flowing through the cavity from the inlet end to exit via the remote end, by-passing all the valve plunger grooves 15 that communicate the plunger cavity 17 with the outputs 5,6 in the contact surface. In a vertical application, gas that eventually is included in the liquid will be vented to the re-circulation passage, from the remote end of the cavity.

The dispensing apparatus is modular by design. A valve module 8, accommodating a first 9 and at least one additional, second valve plunger 10, forms a base for a dispensing module 21 carrying the contact surface 2. The dispensing module may be secured to the valve module through snap lock means 22, e.g., or through other fastening means such as the bolts illustrated in the drawings.

In the valve module, valve seats 11, 12 are formed for insertion of first and second valve plungers 9 and 10 axially from one end of the valve module. Radial shoulders 23, 24 may be formed on the valve plungers and seats, respectively, in order to define in cooperation a limited length of insertion, or the maximum length of adjustment movement in shifting operations. When seated in the valve module, each valve plunger projects with the inlet end outside the valve module, said inlet end being arranged to be coupled to a pump by means of a flexible tubing. The opposite end 25 of the valve plunger, remote from the inlet end, projects outside the opposite end of the valve module to be connectable to an adjustment drive unit 14. In the illustrated embodiment, said adjustment drive unit is an air operated cylinder connectable to said remote end of the valve plunger. The air cylinder may be a double-acting cylinder, or a single-acting cylinder combined with a return spring that urges the valve plunger into the re-circulation mode. An interconnecting element 26, such as the illustrated barrel-type sleeve, interconnects the valve plungers of both said first and second valve units whereby the plungers are concurrently operable in adjustment movements by the singular drive unit. Additional valve units may likewise be operated by a single and common drive unit via the interconnecting element, properly designed. Alternatively, the valve units in the valve module may also be individually operated by separate drive units 14 as illustrated by the second embodiment, allowing when separately controlled a perfect synchronization of liquid output to the moving substrate. As suggested in the drawings, clip holders 27 may be arranged for fixation of the plunger ends in the sleeve, the sleeve in turn connectable to a piston rod through a threaded connection. The drive unit is supported on a casing 28 secured to the valve module, said casing forming an enclosure of the plunger ends and interconnecting elements.

The valve seat and valve plunger are both preferably circular in section, radially dimensioned for a sliding and leak-proof fit. A couple of O-ring seals 29 axially spaced on the plunger define an output section of the plunger/seat-combination, or valve unit.

As already explained, the valve unit output comprises opening members realized as grooves 15 recessed from the plunger periphery, separated by closing members realized as lands 16 which define the radial dimension of the valve plunger, said grooves and lands running about the plunger periphery from a first to a second edge of an elongate cavity 17 opening in the plunger side. Each output in a row of co-extensive outputs 5, 6 on the contact surface 2 is individually communicating with the associated valve unit output via an individual passage 13.

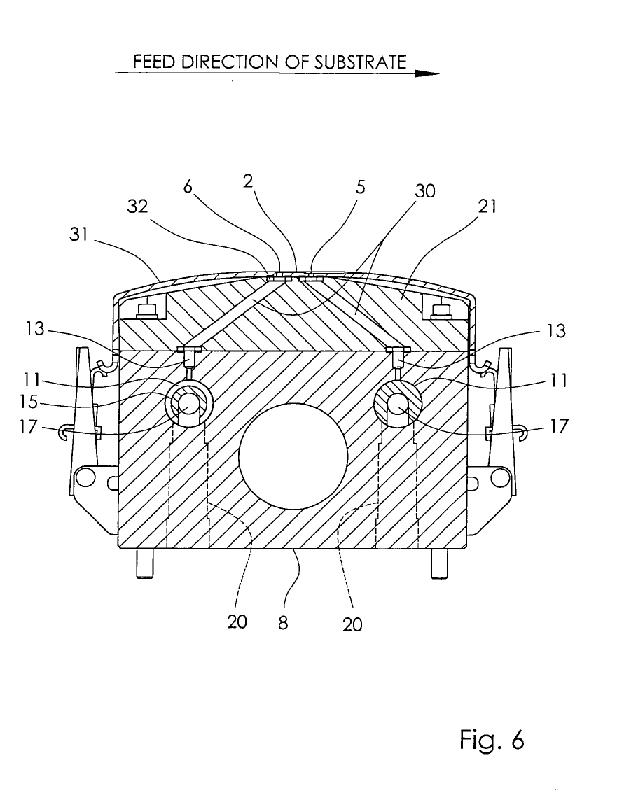

As is best illustrated in FIG. 6, the passages 13 mouthing in the valve seat and on a side of the valve module, provide liquid communication between the valve seat and corresponding passages 30 formed through the dispensing module 21. The passages 13 through the valve module 8 may run in parallel from the seat to the valve module side, or may run in divergent or convergent directions in order to bridge any dissimilarity in the layout of passages 13 through the valve module and the passages 30 through the dispensing module, respectively. Likewise, corresponding passages 30 through the dispensing module may run in parallel from the valve module side to the contact surface side, or may run in divergent or convergent directions in order to bridge any dissimilarity in the layout of passages 30 and the arrangement of co-extensive outputs 5,6 on the contact surface, respectively. Specifically, the liquid flow through the valve module and dispensing module may be guided in convergent passages from valve seats to the outputs in the contact surface, allowing a reduction of the distance between the co-extensive outputs as viewed in the feed direction of the substrates. Such feature may be desirable in order to avoid excessive discharge of liquids at the end portions of the moving substrate, when the two or more valve units are operated by a singular adjustment drive unit.

The channels 7 are stepwise recessed from the contact surface 2 formed on a contact plate 31 made of metal, such as steel or hard alloy, or other wear-resistant material. The contact surface has a trailing end and a leading end, both of which may be adjoined by extensions that are curved or angled out of the plane of contact with the moving substrate. Snap lock means are advantageously arranged for mounting the contact plate 31 to the valve module. In the illustrated embodiment, the dispensing module is bolted to the valve module. At the interface between the contact plate 31 and dispensing module, continuous sealing elements 32 may advantageously be recessed into the dispensing module and arranged to encircle each row of outputs. Sealing elements are likewise preferably arranged at the interface between dispensing module and valve module.

One alternative design (not illustrated in the drawings) foresees that the channels are realized as slots formed through the contact plate, whereas the channel bottoms are provided by protrusions rising above the dispensing module surface at stepwise reducing heights in the feed direction, and fitting into corresponding slots upon connecting the contact plate to the dispensing module. Another alternative design foresees that the channels are completely formed in a block rising above the dispensing module surface, and fitting into a cut out portion in the contact plate. Such channel-blocks may be separate elements, or integrally formed in the dispensing module.

The dispensing apparatus is likewise useful for application of liquids to substrates at vertical or horizontal orientations. When applied for dispensing curable adhesive components, hardener is advantageously dispensed through the first row of co-extensive outputs and adhesive is dispensed through the successive row of outputs, as viewed in the feed direction of the substrate.

The preferred viscosities of the dispensed liquids depends on if the dispensing of liquid is made horizontally or vertically. For vertical dispensing, the viscosities of the dispensed liquids are suitably such that they stay on the substrate as applied, suitably at least about 500 mPas (Brookfield LVT sp3, 12 rpm at 25° C.), preferably from about 500 to about 4.000 mPas, most preferably from about 1.000 to about 2.000 mPas.

In a further embodiment, not illustrated, the dispensing apparatus has more than two valve units and more than two rows of co-extensive outputs. This enables separate dispensing of, e.g., a multi-component adhesive system having more than two liquid components.

In the process of dispensing liquid components to a substrate moving in a feed direction under contact with a dispensing apparatus, several of the problems noted above may be avoided by using a dispensing apparatus as disclosed. In the edge lamination process referred to above specifically, although not exclusively, application of liquid components is performed through a method comprising the steps of forming by said apparatus a string of a first liquid on a substrate, and successively adding a second liquid to said first liquid while forming, by the apparatus, a string of combined liquids on the substrate. In addition, dispensing of successively added liquids may comprise the step of encapsulation of strings of liquid or liquids previously dispensed to the substrate. The process of dispensing may be further improved by the step of continuously feeding the liquids through the dispensing apparatus as disclosed, this way taking advantage of the kinetic energy of the circulating liquid to support the opening/closing sequence, as well as allowing an operation at comparatively low pressure while maintaining a uniform discharge through the valve unit outputs.

The liquids dispensed are preferably components of an adhesive system. Such components are, for example, a resin component and a hardener component of a curable adhesive system. Examples of such adhesive systems are such where the resin component is based on phenol-formaldehyde-, melamine-formaldehyde-, melamine-urea-formaldehyde-, or urea-formaldehyde-resin.

The substrate is preferably a wood based substrate.

The invention is explained with reference to embodiments by which it will be understood, that the basics of the presented solution may be realized in several structural designs while still taking advantage of the invention as defined by the claims.

1. A dispensing apparatus, comprising:
first and second valve units (9; 10) each having an output for delivering a liquid under pressure;
a liquid application means coupled to said valve units, the liquid application means having a contact surface (2) and at least two separated, co-extensive outputs (5; 6) in said contact surface respectively communicating independently with the outputs of said first and second valve units, wherein
said co-extensive outputs mouth in succession into a channel (7) which is recessed from the contact surface, the channel mouthing in a trailing end of said contact surface, and said channel having a flow cross-section that increases stepwise for every additional liquid that is successively discharged through said co-extensive outputs (5; 6).

2. The dispensing apparatus of claim 1, wherein each stepwise increased flow cross-section of said channel has a depth and a width dimension (d; w), both greater than a depth and width dimension (d₁; w₁) of the previous flow cross-section of said channel.

3. The dispensing apparatus of claim 1, wherein said co-extensive outputs include first and second co-extensive rows of outputs, and the output from each said first and second valve units includes individual opening/closing members (15; 16) for each output (5; 6) included in one of said co-extensive rows of outputs.

4. The dispensing apparatus of claim 3, wherein first and second pumps are respectively coupled to said first and second valve units for supplying liquid independently to each valve unit, and the output from each said first and second valve units includes an opening/closing means (19, 20) in flow communication with one of said pumps and operated in the reverse to said individual opening/closing members.

5. The dispensing apparatus of claim 3, wherein said first and second valve units each include a valve plunger (9; 10) that is axially adjustable between opening and closing positions, said valve plunger on its outside carrying opening grooves (15) separated by closing lands (16) running about the plunger periphery, from a first to a second edge of an elongate cavity (17) opening in the plunger side.

6. The dispensing apparatus of claim 4, wherein said first and second valve units each include a valve plunger that is axially adjustable between opening and closing positions, an elongate cavity formed in said plunger, said cavity having an inlet end (18) and a remote end (19) both communicating with one of said first and second pumps, said inlet end continuously opened for supply of liquid into the cavity and said remote end opening for recirculation of liquid to the pump when the plunger is adjusted for closing the outputs in one of said co-extensive rows of outputs.

7. A dispensing apparatus having a modular design, comprising:
a dispensing module (21) supporting a contact plate (31), both mountable on a valve module (8);
at least two valve units, each having a plunger (9; 10) receivable in seats (11; 12) formed in the valve module, and
a drive unit (14) mountable on the valve module and connectable to the valve plungers, the dispensing apparatus further comprising:
separate outputs for delivering a liquid under pressure from each said valve units,
a contact surface (2) arranged on said contact plate (3) and at least two separated, co-extensive outputs (5; 6) formed in said contact surface, said co-extensive outputs communicating independently with the outputs of said first and second valve units, wherein said co-extensive outputs mouth in succession into a channel (7) which is recessed from the contact surface, said channel mouthing in a trailing end of said contact surface, and said channel having a flow cross-section that increases stepwise for every additional liquid that is successively discharged through said co-extensive outputs (5; 6).

8. The dispensing apparatus of claim 7, wherein each stepwise increased flow cross-section of said channel has a depth and a width dimension (d; w), both greater than a depth and width dimension (d₁; w₁) of the previous flow cross-section of said channel.

9. The dispensing apparatus of claim 7, wherein said co-extensive outputs include first and second co-extensive rows of outputs, and the output from each said first and second valve units includes individual opening/closing members (15; 16) for each output (5; 6) included in one of said co-extensive rows of outputs.

10. The dispensing apparatus of claim 9, wherein first and second pumps are respectively coupled to said first and second valve units for supplying liquid independently to each valve unit, and the output from each said first and second valve units includes an opening/closing means (19, 20) in flow communication with one of said pumps and operated in the reverse to said individual opening/closing members.

11. The dispensing apparatus of claim 10, wherein each valve plunger (9; 10) of said first and second valve units is axially adjustable between opening and closing positions, said valve plunger on its outside carrying opening grooves (15) separated by closing lands (16) running about the plunger periphery, from a first to a second edge of an elongate cavity (17) opening in the plunger side.

12. The dispensing apparatus of claim 10, wherein each valve plunger (9; 10) of said first and second valve units is axially adjustable between opening and closing positions, an elongate cavity formed in said plunger, said cavity having an inlet end (18) and a remote end (19) both communicating with one of said first and second pumps, said inlet end continuously opened for supply of liquid into the cavity and said remote end opening for recirculation of liquid to the pump when the plunger is adjusted for closing the outputs in one of said co-extensive rows of outputs.

13. The dispensing apparatus of claim 7, comprising an interconnecting element (26) by which the first and second valve plungers are concurrently operable by a singular drive unit.

14. The dispensing apparatus of claim 7, wherein the first and second valve plungers are individually operable by separate drive units.

15. The dispensing apparatus of claim 7, wherein the contact surface (2) on the contact plate (3) is formed with a leading end (3) and a trailing end (4), both of which adjoin an extension that is curved or angled out of a plane of contact.

16. A method for dispensing liquids onto a substrate moving in a feed direction under contact with a dispensing apparatus, comprising the steps of:
dispensing from said apparatus a first and a second liquid separately via outputs, co-extensive in said feed direction;
forming by said apparatus a string of said first liquid on the substrate, and successively
adding said second liquid to said first liquid, forming by said apparatus a string of combined liquids on the substrate, wherein the second liquid is formed to a string that encapsulates the first liquid previously dispensed to the substrate.

17. The method of claim 16, wherein the liquids are delivered individually to multiple outputs arranged in co-extensive rows of outputs, comprising the step of individually opening and closing, respectively, each output included in one of said co-extensive rows of outputs.

18. The method of claim 16, further comprising the step of continuously feeding the first and second liquids through said dispensing apparatus.

19. The method of claim 18, further comprising the step of controlling the continuous feed of the first and second liquids for recirculation of liquid in reverse to dispensing.
